(19) United States
(12) Patent Application Publication
(10) Pub. No.: US 2018/0308100 A1
(43) Pub. Date: Oct. 25, 2018

(54) SYSTEM AND METHOD OF CLIENT RECOGNITION FOR SERVICE PROVIDER TRANSACTIONS

(71) Applicants: Risto Haukioja, Palo Alto, CA (US); Ray Rahman, San Francisco, CA (US); Eli Sakov, San Carlos, CA (US)

(72) Inventors: Risto Haukioja, Palo Alto, CA (US); Ray Rahman, San Francisco, CA (US); Eli Sakov, San Carlos, CA (US)

(21) Appl. No.: 15/490,970

(22) Filed: Apr. 19, 2017

(51) Int. Cl. G06Q 20/40; H04L 29/06; G06Q 10/02; G06N 99/00; G06N 5/04

(52) U.S. Cl. CPC G06Q 20/40145; H04L 63/102; G06Q 30/016; G06N 99/005; G06N 5/04; G06Q 10/02

(57) ABSTRACT

A system and method for providing merchants and service providers automated identification of proximate clients to provide relevant client data and to authorize transactions. Whereupon a client is discreetly identified by the system through facial recognition, thumbprint, voice sample, iris scan, or other biometric sample. Multi-level authorization and authentication are provided using client metadata, such as email, phone number, mobile device, location, and payment information. The service provider is shown client preferences and transaction history in order to facilitate personalized service. The client is provided with relevant options for available goods or services as recommended by the system. The system provides client sentiment analysis to generate dynamic personalization, customer feedback, and intention projection. Service providers and merchants in the network are curated such that they may be presented to a customer in an orderly fashion. Client participation is incentivized through higher quality service and personalization created by seamless transaction. The recognition system can also serve as an authentication and authorization method to provide customers with seamless transactions, and uninterrupted high-quality service.

### BACKGROUND

Currently available methods for payment and transactions require the use of tangible objects and other specific media for identifying and authenticating the customer and accessing user account data and available payment methods. When a customer transacts with a merchant business or service provider, payment is typically provided with cash, credit or debit cards, or mobile phones. If identification is required, the customer may be asked to provide photo identification such as a driver's license. Electronic transactions that are carried out through mobile applications or web sites regularly ask that the customer provide a name, email address, telephone number, physical address, and credit or debit card number and security codes. Payment may also be provided by linking an available electronic payment system by accessing the user account login and password.

The data available to the merchant or service provider depends on the type of transactions and the willingness of the customer to provide feedback or the business owner's ability to gauge or measure the customer experience. For in-person transactions, the merchant or service provider can readily and easily understand the customer's level of happiness by social interaction, facial expression, or body language. With electronic transactions, the customer's satisfaction may be learned through user submitted reviews, ratings systems, or fillable surveys. A specific merchant may collect data from customers regarding the quality of service, perceived value, likeliness to use again, whether to recommend to others, etc. Through this data, the merchant or service provider may learn about how to make changes to affect improvement in customer satisfaction.

The customer service experience is critical to the relationship between a business and the customer. Merchant or service provider customer interactions depend on the skill level of the staff and/or prior experience or past dealings with the customer. Value is added to the customer service experience by hiring experienced staff, providing training, and developing unique sales approaches tailored to fit the specific business area. A trained staff member may interact with a potential customer on a high level by understanding the motivations, desires, and past history of the customer account. Connecting with a customer and interacting on a social level is a highly advantageous strategy for the sales associate to win new business. It is therefore important for the customer service experience to be managed by experienced staff with access to customer data in order to engage customers in productive manner for the business relationship.

The front desk at a restaurant, merchant store, coffee shop, or hotel is typically occupied with staff personnel who have access to a point of sale (POS), property management, or other reservation system. The computerized systems for transactions, guest check-ins, registration, appointments, or other guest services usually require that the employee staff first ask the guest for their name or reservation information. Upon providing identifying information to the front desk personnel, the guest's information is entered and retrieved with the system. Guests may be asked to provide a name, reservation number, photo identification, or other means to enable the service personnel to access the guest's transaction history or profile information. Currently available methods for identifying guests or clients do not provide for automatic guest account profile and transaction history retrieval without some manual actions by the service provider employee staff. A fully automated method for identifying and accessing a guest's account information would allow the merchant or service provider to increase the level of personalized service and attention given to the client and to offer smoother and faster transaction and payment methods.

### SUMMARY

The present invention provides a system and method for recognition of a client identity for authentication and authorization of transactions with a merchant or service provider. Whereupon the service provider engages with a display and user interface automatically populated with client identity profile data linked to a curated merchant network. Client guest accounts are discreetly recognized using electronic signals such as GPS, Bluetooth, Wi-Fi, and or biometric technology such as facial recognition, thumbprint, voice sample or other identifying trace pattern. Services are provided for completing reservations, checking into hotels, acquiring goods, purchasing tickets, having services rendered, or transacting payments with the merchant or service provider upon identification and authorization by the system. The merchant or service provider is provided with client identity metadata, stored preferences, and other relevant transaction history for use in engaging with the guest. The present system is a multi-sided marketplace, with one side of the market comprised of enterprises and services that are given access to important user accounts and guest profiles. The other side of the market is comprised of merchant accounts and service providers that are pre-authorized by the system owners and maintainers. Payment and pre-authorization for goods and services are tied to the client identity where the person becomes the payment mechanism.

The system contemplates three types of transaction modes. First is where the guest or client makes a reservation to a sporting event, a hotel stay, or a fine dining restaurant, etc. Through this action, the client has informed the merchant network about the intent of going to the place of the reservation, and the service provider schedules the client in the reservation system. In this mode, the client has made the appointment or reservation. Second is the ad-hoc purchase, where the customer visits the merchant or service provider, the system detects and identifies the guest based on facial recognition or geo-fencing (i.e., the user's device is seen by location based sensors), and ultimately the customer obtains the goods or services desired. The ad-hoc purchase is initialized by the client, detected by the merchant's recognition system, and completed through a seamless transaction method. The third type of transaction mode is the pre-purchase. In this mode, the client knows that he or she would like to obtain a particular good or service, for example a coffee, and the client informs the service by sending a text message or pushing a button on a mobile device application. The client then travels to the merchant or service provider to pick up the goods or to receive the service. The actual financial transaction may be completed prior to the client arriving at the merchant or service provider's location.

The guest client identity experience is augmented with sentiment analysis from sensor collected and transaction history data. Dynamic personalization of merchant or service provider offerings is achieved through analysis of client identity usage history, aggregate client or guest patterns and behavior, and biometric sampled data and signals. System client identity metadata may be computed for targeting the guest with relevant services at the time of need and according to perceived sentiment analysis. For example, a guest account may be recognized and identified by the system as requiring attention for a specific need, i.e., the want for information regarding a business location or hours and options available for travel to a particular destination and nearby dining options. Alternatively the system may analyze guest client identity sentiment for its present emotional state and dynamically personalize the service provider offering to affect positive outcome in the guest. In this use case scenario, the merchant may be alerted that the guest is “tired” or “unhappy” and the relevant offering: Cafe Americano, will be creatively and delightfully provided to the guest. In another alternative embodiment of the system, the service provider may be notified that the guest is approaching with anger and/or resentment from a poor customer experience. In this scenario, the service provider staff will be notified as to the approaching client's emotional state. The system will dynamically assign a well-trained staff member to intercept the client, provide courteous and professional support, and pre-empt the creation of a tense situation or unproductive exchange between the customer and the service provider, therefore mitigating potential damage to the relationship.

In order to register guest client identities, the system may utilize mobile app based identification with camera picture access, client identifying photo, and preferences provided by the user and stored transaction history. Email address and phone number data may be stored by the system as well as fingerprint and voice sample. Identifying data are collected by the system mobile application, terminal display user interface, or sensor hardware and allow the computation of probabilistic modeling and certainty of identification of the user or guest account profile. Overlapping the collected data in a multi-layered approach with facial recognition, voice sample, or fingerprint sample will drive up and increase the probability of certainty of identification of the guest client identity by the system. Payment and transaction authorization is approved upon reaching a predetermined high probability of recognition accuracy level.

Sensor arrays and other biometric hardware will be available at the merchant or service provider location for gathering and collecting input data from electronic, visual or audible sources. Input data may be acquired from cameras, microphones, or wireless beacons. The system input processor receives sensor array data and provides facial recognition and featurization. Probabilistic models are computationally performed on facial recognition and featurized data with the goal of achieving identification and match with the profile database or sign up accounts and data pipeline information. The cloud based identification service is accessed at the location front-desk terminals and displays identification and signup information. Payments, check-ins, or withdrawals are written to the transaction ledger. The authorization service pulls identification data and front-desk terminal information to send for recording to the transaction ledger.

The system recognition engine receives sensor array data from cameras, microphones, or beacons/wireless signals for analysis. Alternatively, events are gathered from the location based sensory arrays and front-desk display terminals in the event pipeline and passed to the recognition engine for analysis. The recognition engine analyzes the sensor input or event data with facial recognition, machine learning, or probabilistic models. User or guest client identity identification in the cloud based system is reached with information from the recognition engine which is compared with the profile database to find signups and other user profile related data pieces in the data pipeline. The authorization service utilizes the identification match to connect with front-desk terminals at the merchant or service provider location to send and write payments, check-ins, or withdrawals to the transaction ledger.

The overall system is cloud based whereas the sensor array and front-desk terminals are available at a physical location. The system may integrate with existing point of sale (POS) systems and hardware. The cloud based system may also receive event data, sensor data, or biometric samples from the on-person based device. A preferred system design approach provides for cloud-based sensor fusion from data collected at the merchant or service provider location sensor array hardware with cameras, microphones, beacons or wireless signals.

User accounts are created during the sign up or a batch input process during which the system collects basic client guest identifying information and financial payment account information. The system data pipeline feeds user account information into the profile database. User accounts and profiles are maintained in the profile database for access by the recognition engine. The cloud-based recognition engine analyzes input data from sensors and provides a user-interface across front-desk terminals and displays such as tablet computers, point of sale systems, desktop computers, mobile phones, monitors and other display terminals. The recognition engine processes sensor data using facial recognition and or other transformations, then feeds the processed signal into probabilistic algorithms, such as neural networks, decision trees, Bayesian models, and other machine learning algorithms to match a signal to a client profile.

Facial recognition may be supplemented with guest or client identity metadata to improve accuracy and create recognition services. Guests or client identities may be identified with a recognition algorithm by weighting face matches with the conditional probability it is in fact a particular guest or client identity given that particular guest or client's transaction history or preferences data. The conditional probability given facial match and background information may be estimated with the example of combining user history with machine recognition to improve accuracy.

### DESCRIPTION OF THE DRAWINGS

FIG. 1 is a view of the multi-sided marketplace for Demand Partners (Hotels, Luxury Condos, etc.), Direct Demand (consumers), Supply (Merchants), and Shared Services. The consumer client identity uses the system for discovery of accommodations and services, reservations, seamless payments, ratings, and sharing functionality. Demand Partners, Hotels, Luxury Condos, etc. utilize recognition, profiling, curation, reservation, seamless payments, and rating services. Supply (Merchants) utilize recognition, reservation, personalization, rating, seamless payments, ratings, and re-engagement functionality. Shared Services are available in the marketplace for seamless payments, merchant services, identification & authentication, discovery & reservations, and loyalty functionality.

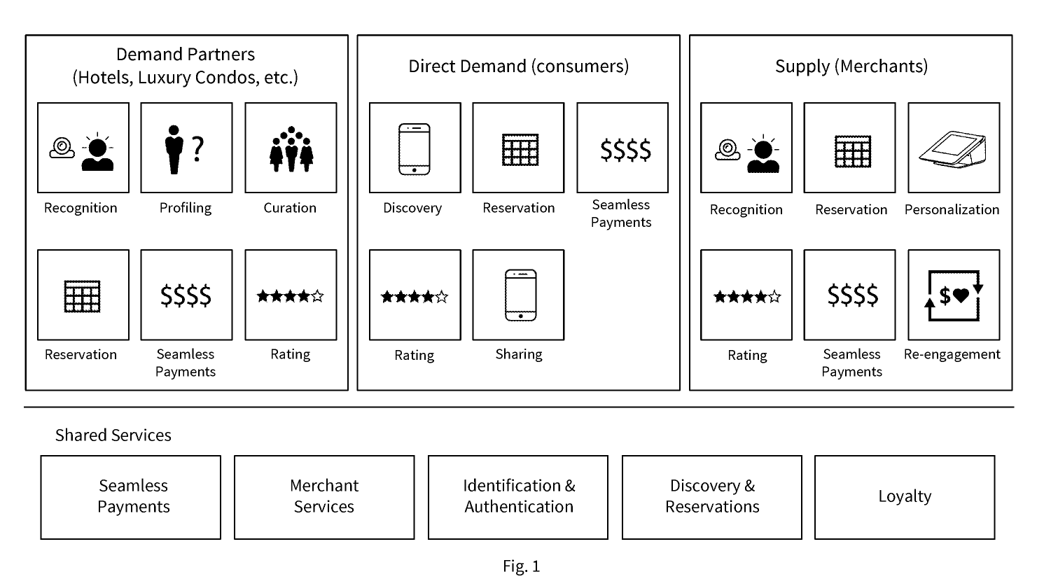

FIG. 2 is a view of the multi-layered authentication and authorization model where the client identity name is provided at account creation and sign-up. The user's email address is validated, as well as a pre-authorized credit card, phone number, photo & facial recognition against a validated photo ID, GPS, Bluetooth, Cellular or Wi-Fi location data, and fingerprint reading and audio signature from phone. Payment methods with credit cards are authorized for small purchases with account creation, while larger purchase amounts are authorized with additional layers of identification and authentication in the system.

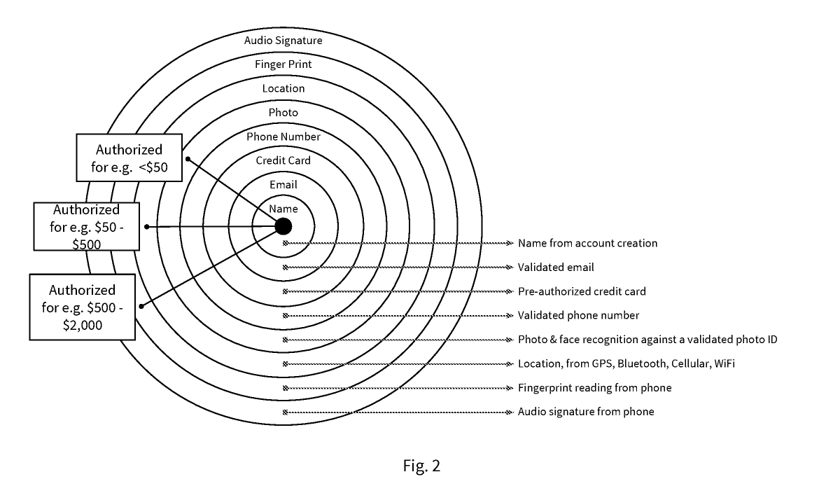

FIG. 3 is a view of the general system design with in-cloud probabilistic model/Machine Learning (ML) for Identification and Authorization. Location based sensor array (Cameras, Microphones, Beacons/Wireless signals) provides biometric data to the input processor for Facial Recognition and Featurization. Identification in the profile database allows authorization and access to the transaction ledger for payments, checkins, etc., and display at front-desk terminals.

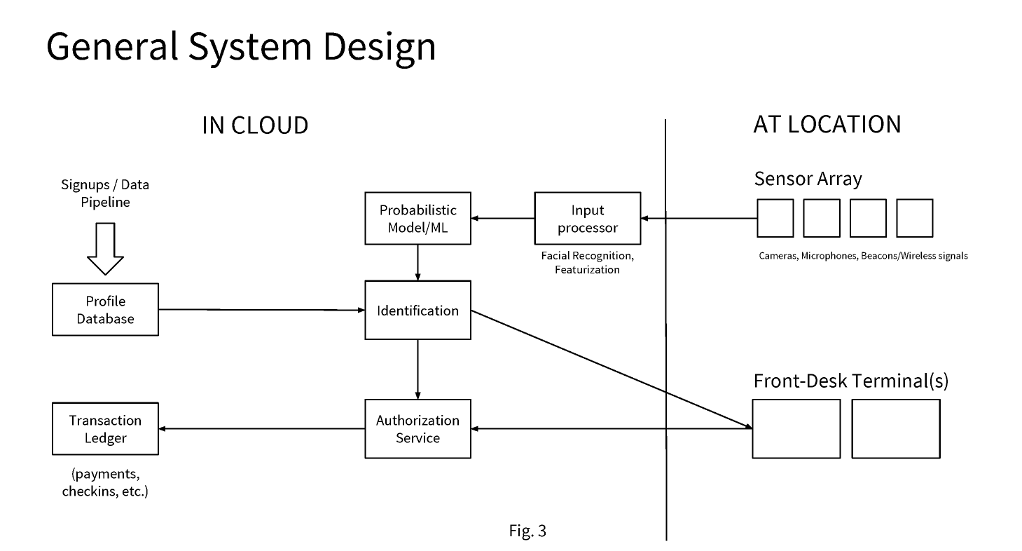

FIG. 4 is a view of the general system design specific use case involving a device-on-person, location based sensor array (Cameras, Microphones, Beacons/Wireless signals) and front-desk terminal(s) (Tablets, Computers, Phones, Monitors) sending event data through a general-purpose Event Pipeline. The Recognition Engine (Facial Recognition, Machine Learning, Probabilistic Models) combines ML (Machine Learning) with signups/data pipeline & Profile Database information for the Authorization Service access to payments, checkins, etc. in the Transaction Ledger and display on Front-Desk Terminal(s)

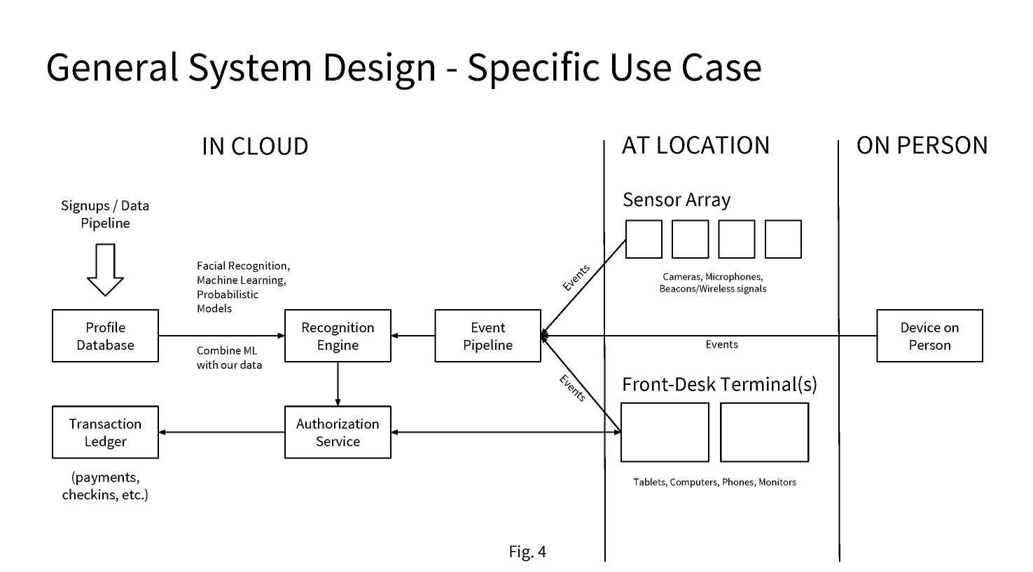

FIG. 5 is a view of the general system design sensor fusion of device-on-person and sensor array data for the recognition engine. The recognition engine (Facial Recognition, Machine Learning, Probabilistic Models) receives the combined sensor fusion data, and accesses signups/data pipeline, profile database information, combines ML with system data, and authorizes transactions with the transaction ledger for payments, checkins, etc. and display on front-desk terminal(s).

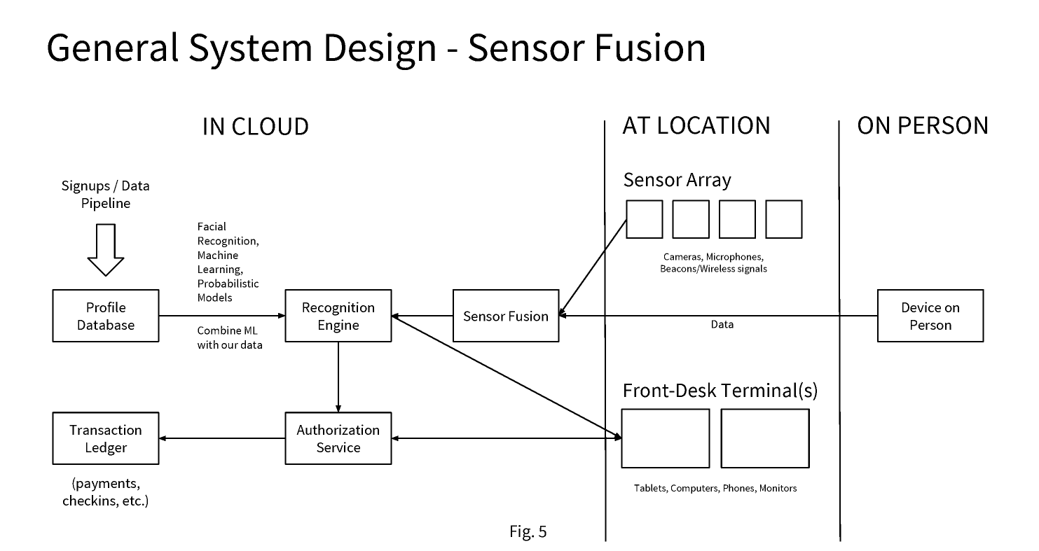

FIG. 6 is a view of the simple system architecture with the sensor array or hardware transmitting to recognition which authenticates and authorizes current and past guest activity and provides data to terminals.

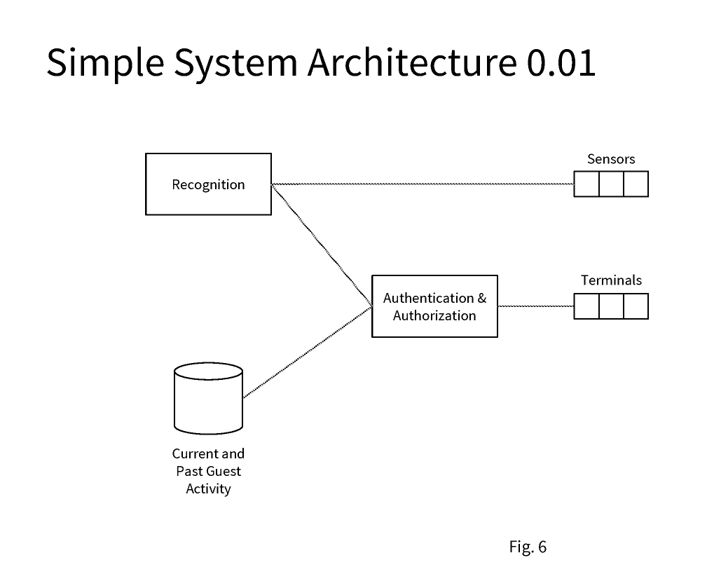

FIG. 7 is an enumeration of the sensors types and recognition processes used. Sensor hardware may be comprised of cameras, microphones, GPS signals, Bluetooth, and wireless beacons, wireless signals, RF sensors, mobile & stationary apparatus, activity trackers, compasses, thermometers, photometers, or pressures sensors. Sensor data and signals acquired from sensor hardware and apparatus are transmitted to the recognition processes: facial recognition, voice recognition, digital signal processing, location tracking, pattern matching, machine learning, sentiment analysis, intent recognition, or velocity & direction tracking.

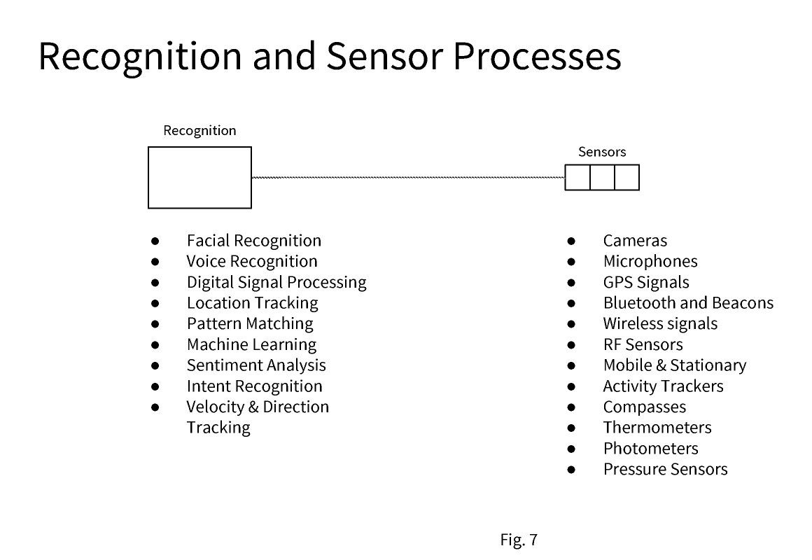

FIG. 8 is a detailed view of the identity communication process between the terminals and authentication and authorization process. Guest identity is sent to n terminals based on authentication. An authorization transaction may be sent on behalf of the guest with transactions being written to the transaction ledger. Terminals receive identities of incoming guests, terminals are notified of incoming guests or trigger processes using guest data, terminals receive personal data for each guest, actions are performed with guest data, and the system initiates the transaction with the guest.

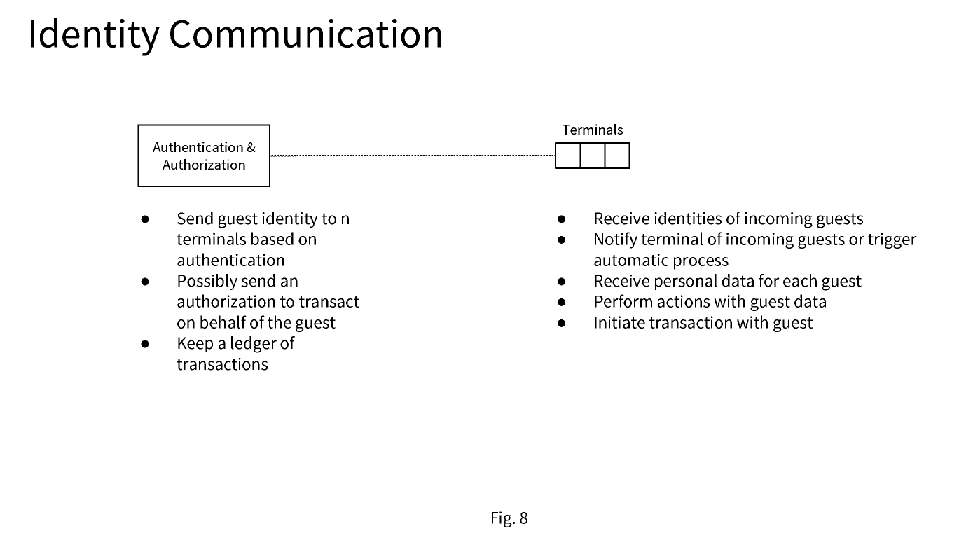

FIG. 9 is a representation of the Data Pipeline from batch import and user registrations into the guest database and recognition system. Existing sources of data are guest lists, customer lists, or public data, which are received at the Data Feeds in User Signups (User Opt-In, or Merchants). Data is combined at the signup processor with information from Recognition, Biometric Index, Profile Data, and Current and Past Guest Activity.

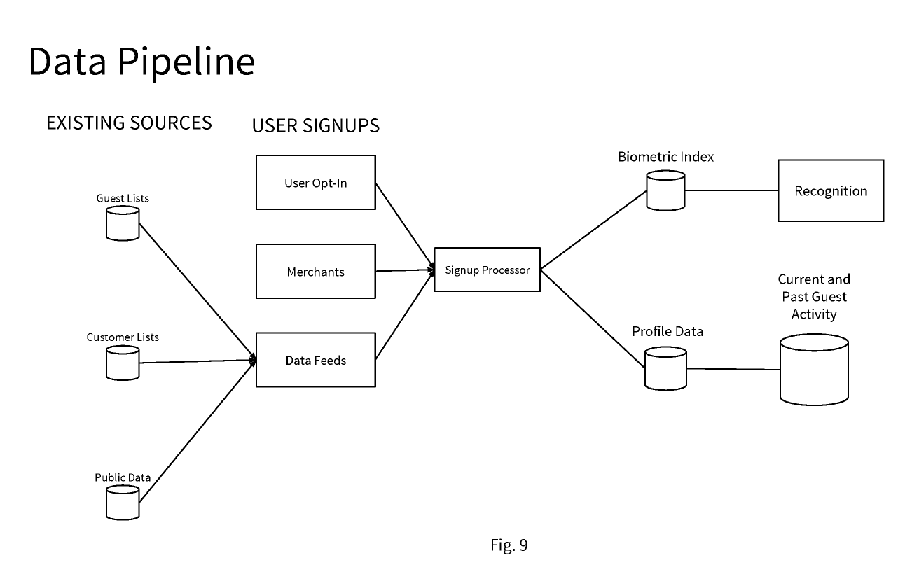

FIG. 10. is a view of a simple reference implementation of the system at a service provider Hotel. The location based On-site Camera provides data to cloud-based Kaliber Guest Services. Relevant Guest Data is send to Guest Collection in AWS Rekognition for Guest Recognition provided to Kaliber Guest Services and transmittal to the terminal display or Front Desk iPad device for showing recognized guests or client identities.

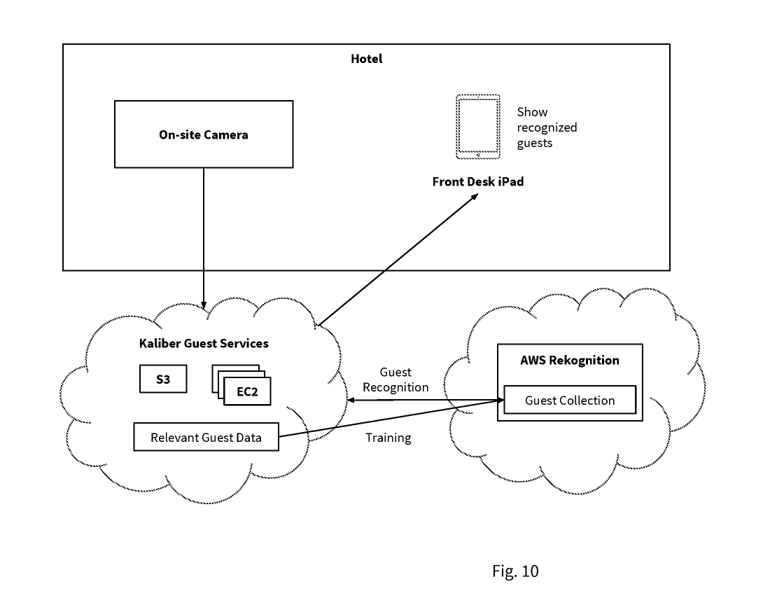

FIG. 11. is a view of a detailed reference implementation of the system at a service provider Hotel. On-site camera(s), i.e., Raspberry Pi+USB Camera(s) with a 4G Hotspot provide picture or image data to ELB (send-face.kaliberlabs.com) and the Kaliber Face API Server with AWS Rekognition (Guest Collection) services. A face match is returned to the Kaliber Face API which stores images in live view and user match. The State Server is updated with guest or client identity recognition and the terminal display or Front Desk iPad device listens for changes and gets updated picture and metadata about the guest or client identity.

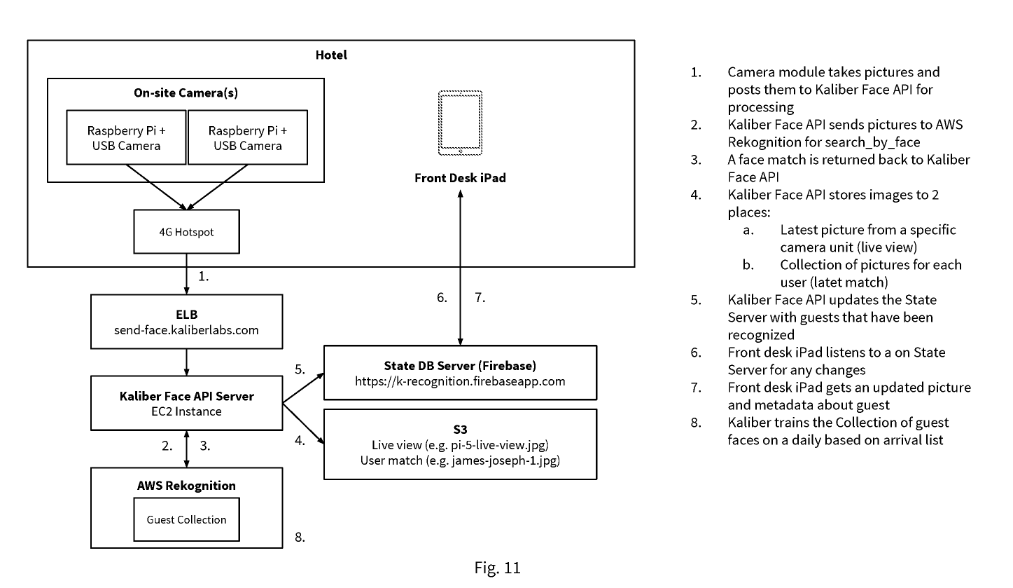

### DETAILED DESCRIPTION

A user, client identity, or guest account is created in the beginning of the service. A client identity account may be generated by downloading and installing the mobile device application. Alternatively, a client identity account may either be created without the mobile device application or via a batch import from trusted sources. For example, a customer may visit a merchant or service provider and be asked to join the service or platform. The customer's picture will be taken (or other biometric data sampled) and that customer's client identity will be added to the database. In another alternative example, the service provider hotel may have identified a customer and may ask if they would like to sign up for a Kaliber VIP account to get personalized service with a curated network of merchants. Upon acceptance, the customer's client identity will be on boarded to the system and ready for use with the services.

A client identity account email address is validated during signup. A phone number may also be provided during account creation for added security and verification of the user account. For example, the merchant or service provider may tell the customer that their phone number is on file and a notification of the service activation will be sent via text message. Additional identification is available through photo validation of the new user account by prompting the user to take a photo of their driver's license and matching the name to the new account. Location data may additionally be used with comparing to known system locations. Payment information is provided with credit card account number(s), bank account information, social media site login and authorization, enforcement and verification by friends of the system, or stored transaction history. Payment information is asked from the user upon confirming reservations, purchasing goods, or reserving other service provider offerings or merchant goods.

Biometric data such as facial recognition, iris scan, fingerprint, or voice sample may be collected to authorize and verify the new user account. Wireless signals such as Bluetooth, Wi-Fi may be used to strengthen the identification and verification of the new user account. Facial recognition is an important tool in the system for identity matching. Merchant endorsements are an additional means of supporting the new user account identification which may be provided with in-person merchant face-to-face recognition. Recent photos created during a new user account transaction may be collected from location based camera hardware for identification purposes or for recording the transaction. The user account activity history, calendar event aggregation, active and passive transaction affirmation, transaction ratings, or text message confirmation are additionally available means for identifying and verifying the guest user account.

The system database may track guests across locations, transaction histories, and preferences to customize service. The system may collect real-time data, including guest location, guest transactions, event data, menu data, user interactions, and service events in order prevent fraud, keep a transaction ledger, target offers, and personalize service. The database may collect experience ratings and reviews from merchants and customers, as well as sentiment in order to model, record, improve, and analyze merchant performance and customer satisfaction. Using extensive customer histories, the system may use machine learning to automatically curate and personalize services. Customer and merchant satisfaction can be used to target, improve, and customer experiences and service offerings in the future.

Probabilistic models are computationally performed on facial recognition and featurized biometric data for identification and matching with the guest or client identity account profile database or sign up accounts. Biometric facial recognition data is supplemented with guest or client identity metadata to improve accuracy of identification and to create recognition services. An algorithm may be applied to recognize guest or client identities, for example, by weighting face matches with the conditional probability it is a guest or client identity given a guest or client's history. The algorithm may estimate the conditional probability of a given face match and background information by combining the guest or client history with machine recognition to improve accuracy. Where the algorithm factors the probability it is a specific guest or client identity as output of the face match; the probability the observation is of that guest or client identity at a specific location; the probability the observation is at that location given the guest or client identity; and the probability of having an observation at that location. Payment methods where the consumer pays using facial recognition as a primary or complementary means of proof of payment may be available to the user for merchants or service providers that offer the service. To enable this payment method for themselves, the user must provide a selfie or other identifying photograph and a payment method such as a credit card or bank account. The selfie and payment method may be added to the user account through the mobile device application. Thereafter, the user will be able to browse merchants and service providers that offer face recognition as a payment method. The user will be able to transact with merchants equipped with facial recognition technology and biometric sensors at the merchant location. For example, the user may visit a merchant, order a specific food or drink item, and complete the transaction where the only proof of payment is their face being recognized by the payment technology.

Alternatively, the system may be used without a payment method provided by the user for better customer experience. For example, a user may have identifying information uploaded to the service, such as a selfie photograph or other biometric data. During a visit to a service provider or merchant store, the user is recognized by the service and greeted by the service provider staff. A user may have pre-ordered a specific item with the mobile application and will then travel to the merchant location to retrieve the item or have a certain service rendered. At the service provider location, the user will be recognized, greeted, and given the item or service. The transaction will the completed by providing a conventional payment method to the service provider, at that time, by the user.

In another embodiment where identification is provided by the system, but the payment method is separately completed by the user, the service provider may be a hotel. The user will be previously on-boarded via batch import or by installing the mobile device application, signing up for the service, and providing a selfie photograph or other identifying information. The service provider hotel staff will be able to provide an improved quality of service through facial recognition of guest accounts and the offering of a more personalized service. The result is an improved customer experience without any payment information being required.

The service provider user interface for the merchant ecosystem is available to service staff typically working at customer facing locations as part of the system. The staff employee is provided with guest account identification and recognition information. For example, when a certain guest walks into a service provider hotel, the service provider user interface will display the guest's name and identification information. The staff employee will be able to properly greet and accommodate the guest with the identifying data. The system may provide transaction history data for the guest account, such as how many stays at the hotel, other identities or accounts used, loyalty programs, or ratings information, etc. The staff employee is given transaction ratings options in the service provider user interface and may additionally keep notes about the guest. For example, the staff employee may select that the guest was a happy customer and record personal information or notes regarding the guest's preferences.

In another preferred embodiment of the system and method, the customer is on boarded by the service before traveling to the merchant or service provider location. Through the mobile device application, the service asks the customer to provide a selfie photograph and/or a photo of their driver's license. Thereafter, upon walking into the hotel where the customer has a reservation, the customer's client identity will be discreetly recognized by the system. Furthermore, if the customer has a payment method associated with the client identity, the front desk staff will be provided access to this payment information without having to ask the customer. This allows the provision of a higher quality of service by the hotel staff. The staff will be provided access to the client identity profile information in the service provider display user interface. The staff will be free to focus attention on greeting the customer and giving personalized service and attention without the need to ask for the customer's name or payment information.

Device location is an available method of identification of the guest user or client identity. The client identity may associate a mobile device with the system and the account profile. The authenticated mobile device is detected at the merchant or service provider location and the client identity is then identified and verified. For example, a guest or client identity may transact at a merchant location for the purchase of goods and the client's mobile device is detected by sensor array hardware at the location. Device location detection provides a simple means and layer of guest or client identity recognition. Alternatively, clients may be detected at a merchant location through facial recognition, voice sample, or other biometric recognition. Additionally, the merchant or service provider staff may identify the client identity's presence at the location and provide updated verification to the system.

A preferred embodiment of the system identification process is a multilayered trust and authorization model. The user or guest account gets authenticated and authorized with biometric samples such as a fingerprint or iris scan. The user authentication event is additionally layered with photo identification, audio or voice sample recognition, facial recognition, device signal verification, or location-based sensor data. With the aggregation of the identification and recognition data, the system may authorize transactions with varying levels of trust and security. The user account banking and payment information is accessed for providing to the merchant or service provider.

A preferred embodiment of the system multilayer authorization and payment model may be comprised of a number of different identification methods and corresponding activation processes with complimentary required actions by the guest or client identity for different classes of purchase transactions. For example, higher dollar amount purchase classes will require multiple layers of guest or client identity identification methods in order to increase trust levels within the system. A preferred embodiment of the guest user or client identity may be the Kaliber Account which is activated or created during the new user sign-up process. Phone number information is added at the mobile app signup event, and confirmed at sign-up via text message verification. Email identification, photo identification/facial recognition, text message confirmations, or one-time passcodes may be utilized by the system for identification and authorizing new guest user or client identities. Additional layers of identification may be added with social media site account information, enforcement by contacts, merchant endorsement, or merchant recognition.

For example, the system may prompt the guest user account to provide access to the user's social media account such as Facebook, Instagram, or Twitter. The system will access the social media site account information with the new user guest account on the Kaliber Account system for multi-layered identification and authorization. In an alternative identification method, the system may enforce the new guest user account by utilizing access to the guest user's contact list. For example, during new user sign-up process, the system may import the contact list of the new user and verify contacts across social media site accounts for layered authentication. Alternatively, personal contacts of the client identity may identify the new user in the system by passive activity, such as attending the same event, dining together, or completing a transaction together; or personal contacts may actively identify the new user by affirmatively confirming that “you were together” for an increased layered authentication method.

Peer to peer identification through enforcement by contacts builds trust in the system by leveraging known personal contacts of the client identity. Linked social media account profiles of the client identity are rich with data regarding user's contacts, friends, and social activity. Photographs, comments, contacts lists, location data, and activity levels from the client identity's social media accounts may be harvested by the system for increasing identification and verification of the client identity's true identity. Regular activity on the client's social media account from other known and verified client identities will provide a multi-layered basis for identification and trust within the system. For example, the client identity may be observed to have regular “likes” or comments from another known client identities that appear in the client's contact list provided during sign-up. The match or layering between known social media accounts, contacts lists, and other client identities will increase the overall level of trust and identification of the new user.

User account identification from merchant endorsement is acquired through the feedback provided to the system by the merchant or service provider. For example, the client identity will transact with local merchants or service providers on a daily basis and these providers will come to have personal common knowledge of the client. The merchant will be incentivized to endorse the client identity for increased identification in the system in order to improve overall customer experience and ease of transacting business. The merchant may simply state that the client identity has a ten out of ten star rating or may additionally provide unique feedback such as affirming that “Customer X is a good customer”. More generally, the merchant or service provider may provide recognition data for the client identity by stating that “The customer is X”.

Over time, guest and client identities will accumulate an activity history of past transactions, mobile device locations, activity levels (i.e., walking, running, driving, etc.). Additionally the system may be provided access to the client identity calendar events, such as who the client is with, where and at what times. The calendar data may be used by the system for identifying the client identity through activity patterns and event data. For example, the system may detect that the client identity goes for a run every morning and match the activity level pattern with the Kaliber Account for that same unique activity pattern and enable transactions based upon such data. Alternatively, the system may see that a guest user drives to and from work along a particular route every day and match this information with data regarding the year, make and model of the automobile driven by the client identity. Through this pattern matching method, the system may identify and authorize transactions for gas or fuel station purchases for the client identity. Additionally, the system may compare event data as measured by location based sensor hardware, mobile device location information, and calendar event data for identifying the client identity. The system may detect that the client identity has a booking tee time to play golf at a particular golf course at a certain date and time and match the client identity's mobile device location data for authentication of the transaction and payment for the 18 hole golf course green fees.

Biometric samples are available methods for client identity identification and recognition by the system. For example the system may acquire facial recognition, fingerprint reads, voice samples, or iris scans to provide additional layers of identification. A guest user or client identity will typically be incentivized to provide the biometric samples to the system sensor hardware. For example, the client identity may visit the hardware store for the purchase of home improvement supplies. Upon entering the store, the client will be recognized by the facial recognition system and be provided with sales offers related to the current home improvement project that the client is undertaking. A client identity that is working on painting the interior walls of his or her home will be provided with information regarding relevant tools and supplies upon greeting by store employees. The hardware store employees will be provided with access to the client identity preferences and past purchase information by the system upon facial recognition of the client identity. The client identity may be incentivized to save time in selecting tools and supplies by providing a fingerprint sample to the system for increased identification and authentication of the client identity. The system will provide the store employees with the client's information and suggested shopping list and the items will be brought to the client for selection and time savings.

In another preferred embodiment of the system biometric identification and recognition process, a guest or client identity may go to a sporting goods store for the purpose of planning and acquiring merchandise for an upcoming hiking and camping trip. The client identity may provide fingerprint and voice sample upon entering the sporting goods store for the retrieval of user account history and data regarding the planned outdoor adventure location, calendar information, and preferred activities. The store employees and staff will be provided with the client identity's information regarding the planned trip. The client identity is incentivized to provide the biometric sample data to identify and dynamically personalize the visit to the sporting goods store. The benefits received by the client identity will be in the form of receiving expert knowledge and information from experienced staff, proper selection of gear and equipment, and personalized and improved overall customer service experience.

Another embodiment of the biometric sample identification system may be employed in the use case scenario of a long line and significant wait time to get a table for dinner at a popular restaurant. The client identity is incentivized to provide a voice sample at the host reservation counter in order to reduce the wait time for a table. The system will utilize the voice sample of the guest user to match with a client identity profile on a mobile device and provide the client with updates on table wait times. The client will be free to leave the line or waiting area and not worry about missing the upcoming table availability. The system will dynamically provide the client's mobile device with updates for the table wait time and ensure that the client does not have to wait in a line or stay confined to the waiting area. The technology provided here essentially eliminates the act of “waiting in line” by virtualizing physical lines or queues into the system with collected identification and user account data.

Mobile device authentication may additionally provide identification of the client identity with Wi-Fi, Bluetooth, GSM, LTE, or GPS signal location data. The client identity may be associated with a unique mobile device for identification purposes. For example, the client may be logged into the system with the mobile application and connected via Wi-Fi or GSM/LTE cellphone signal to the network. The system will recognize the mobile device name, operating system or mobile application version, serial number, or other unique device identification number. The mobile device hardware and software identifying information and data will be collected by the system for client identification and authorization purposes. For example, during transaction history activity, the system will recognize that the client identity has continuously used on numerous occasions the same identical iPhone or Android device alongside the purchase of coffee at the Starbucks near the client's place of work. By layering the mobile device identification information with the client identity's regular purchases and location information, the system will have a high probability or authorizing the client's mobile device for matching with the client identity and pre-authorizing purchases. Alternatively, the client identity may utilize a particular mobile device for navigation purposes in traveling to and from work. The mobile device GPS signal data will be provided to the system for identification purposes of the client identity.

Driver's license information or background check data may be utilized by the system for additional layers of identification and authorization. High dollar amount or large purchases will require additional layers of client identity information for authentication and authorization of the purchase. For example, a client may wish to purchase a new automobile from a car dealership. In this use case scenario, the dealership may require facial recognition and fingerprint data to complete the transaction. The client will have their face recognized by the system location based sensor arrays and additionally provide a fingerprint reading. With these multiple additional layers of identification, the dealership will properly authenticate and authorize the client identity for the purchase of a new automobile.

Preferred guest or client identity payment methods are credit or debit cards, bank accounts, online accounts, or electronic payment methods. The guest or client identity may add credit or debit cards to the system by taking a picture of the card, or manually entering the account number, expiration date, and security code. Credit or debit card account transactions are authorized by the system through pre-authorization with a sum that depends on the reservation type, goods purchase, or service ordered. For example, the client identity may add a credit card to the Kaliber Account user profile by taking a picture of the card with a mobile device app user interface and entering any required security codes, pin numbers, or passcodes. The credit card may then be pre-authorized by the system for small to medium purchases for the new client identity. As the client builds a transaction history, merchant endorsement, and reputation score, the system may allow larger size or higher dollar amount purchases on the client identity credit card. In tandem, the system will authorize credit card purchases based upon varying levels of the multi-layered identification. For example, small purchases of food or drink may be made by the client identity with minimal levels of identification, such as merely a face detection, fingerprint scan or voice sample. Large transaction and high dollar amount purchases will require added, stronger or combined layers of identification for the client identity. For example, the purchase of a new automobile through the system may be completed with the identification of the client identity with facial recognition, voice sample, device location data, and other trusted identification methods.

Transaction history for a given guest or client identity may be used by the system for identification purposes. With an accumulation of a steady flow of reputable transactions, the system will rely on the transaction data for identifying and authorizing the client identity. For example, a client identity that regularly transacts with a local grocery store for a certain value amount on a weekly basis will be identified and authorized by the system for similar transactions without the need for providing physical payment methods. Alternatively, a client identity that regularly logs into a mobile device to purchase clothing from an online retailer will be identified by the system and authorized to make purchases according to patterns recognized in the transactions by the system. A transaction record during a live purchase at a physical merchant or service provider may be recorded by the system. The transaction record may comprise of photos of the customer carrying out the transaction. For example, at an authorized merchant location, the system may acquire photos of the client identity customer buying coffee and the data will be stored in a layered approach for identification purposes.

The system may collect transaction ratings from merchants to track customer quality. For example, if a customer gets drunk in a restaurant and causes a scene, the restaurant staff may rate him poorly and mark his profile negatively. The system may use this information to ban or discipline clients, and help merchants understand which of their customers are likely to cause trouble. The system will also collect payment metadata to model the credit-worthiness of customers and facilitate transaction authorization. For example, if a customer's payment method were declined while paying for a meal at a restaurant, that information would be recorded and the customer could be unauthorized for larger transactions in the future. The system will measure both customer quality and credit-worthiness, and combine data from both sources into a generalized authorization framework.

In an alternative embodiment of transaction ratings, the client may provide feedback for the merchant or service provider experience. For example, the client may have completed dining in a restaurant serviced by the system. The client will receive a push notification on the client's mobile device that references a line item from the check. The notification may read, “How was the fish fillet?” Or alternatively, “How was the customer service at the restaurant tonight?” Alternatively, for the use case of checking into a hotel, the system may ask the client via push notification, “How was the checking in experience at the front desk?” In each situation, the client will be able to proactively provide a transaction rating and via the mobile device application. Transaction ratings may alternatively be passively detected by the system through sentiment analysis of biometric sensor data.

Sentiment analysis is an important part of how the system engages with the multi-sided marketplace of merchants, service providers, and client identities in order to drive usage and adoption, deliver dynamically personalized service, and affect increased happiness in the overall experience. It is important for the business owner to understand at a fundamental level how the customer is feeling. The emotional state of the customer before, during and after the transaction experience is crucial for a business owner to understand and maintain a high quality of service. For a small business that provides a convenience to its customers, but cannot otherwise compete on price, the understanding of sentiment feedback is the difference maker in fostering repeat customers. The survival of the business depends on satisfying and exceeding the expectations of each and every customer or client identity. In most situations, the business owner is not able to obtain information on every transaction by asking every single customer for feedback. However, access to such information is vastly important to the business owner. Therefore, the present system provides a method for revealing customer sentiment through feedback analysis of collected data.

The system is trained to learn and understand client sentiment and emotions through machine learning, facial recognition, voice sample, activity levels and other biometric sampling techniques. Emotional states recognized by the system may be identified as: happy, sad, annoyed, frustrated, angry, formal, casual, enthusiastic, gleeful, afraid, silly, love, aroused, peaceful, embarrassed, pride, apologetic, disapproving, elated, confused, cautious, exhausted, tired, hungry, lost, exasperated, shame, furious, fear, envy, condescending, anxiety, depression, etc. By extension, a customer that asks many questions throughout the transaction process will be understood by the system to be in a confused state and the system will notify the merchant or service provider to re-think or re-engineer the offering and transaction steps in order to improve service.

Client sentiment analysis is also performed across aggregate customer data. Sentiment analysis may be analyzed across entire customer populations for the determination of baseline customer satisfaction. Additionally, aggregate customer satisfaction may be analyzed across time periods for the determination of customer satisfaction trending. For example at a five star hotel where the service response rate for responding to customer service requests is way below a certain threshold, i.e., one percent, then the system will compute the customer sentiment on a broad basis as they are entering or leaving the hotel property. Furthermore, the system may collect check-in data from guests as they arrive at the hotel lobby. Clients will engage with the hotel concierge for providing check-in procedures and obtaining access to the room. During the check-in process, sensor hardware arrays will collected voice sample or facial recognition data from the client and may, for example, determine that the client is anxious. The system will dynamically personalize a means for speeding up the check-in process and getting the client to the room faster in order to alleviate the anxious state.

Aggregate customer sentiment analysis may be visualized across date and time periods for determining customer satisfaction trending. For example, the system may determine a baseline of customer sentiment and compare that value over weekly variations. Thereafter, trending and correlation computation is performed to tie customer sentiment and satisfaction to specific time, dates, and events. In an exemplary use case, the merchant or service provider may determine that the customer sentiment resonated poorly during the hiring of a new general manager, and that customer sentiment is trending down, without any required feedback from the customer population.

Projecting customer intentions is another important aspect of the system in providing dynamically personalized information and feedback to the service provider or merchant. The understanding of what the client desires, where she is going, how she is going to get there, and what she is going to do when she gets there are exemplary data points for computation by the system. For example, the system may understand the intent of the client identity as wanting to visit her family during an upcoming holiday vacation period. This may be evident by increased social media activity with family members, personalized communication via text or email, or from calendar entries specific to the event. The system will therefore understand the need for plane tickets to be booked on particular dates, to and from particular airports, and will offer up available flights for selection by the client. Intention projection will be presented in an unobtrusive manner as to productively engage the client in a meaningful and helpful way.

1. A method for recognizing a client identity for a merchant or service provider comprising:
sampling client biometric data at a sensor array, wherein the client biometric data comprises facial, voice, or thumbprint data;
recognizing the client identity; wherein recognizing the client identity comprises matching the biometric data with a client identity profile;
authenticating and authorizing merchant or service provider access to the client identity profile, wherein the client identity profile comprises at least a name or account information;
displaying the client identity profile information on a merchant or service provider user interface; and
collecting and storing current and past client activity, preferences, and transaction data with the client identity profile.

2. The method of claim 1 wherein a probabilistic model or machine learning algorithm is used for matching the biometric data with a client identity profile.

3. The method of claim 1 wherein electromagnetic signal (EM) data is used in conjunction with or, instead of biometric data; wherein EM data includes Bluetooth signals, Wi-Fi, GPS, GSM, CDMA, or LTE emissions, or infrared light; and wherein EM signals are collected by sensors such as passive infrared motion detectors, Bluetooth beacons, or Wi-Fi routers.

4. The method of claim 1 wherein the client identity profile may comprise a person's name, account name, account number, transaction history, email address, phone number, photograph, fingerprint, voice sample, biometric data, location, payment method, bank account, credit card, or debit card.

5. The method of claim 1 wherein a multi-layered approach is used for authenticating and authorizing merchant or service provider access to the client identity profile, allowing automatic payment, and wherein transactions or purchases are authorized with additional layers of client identity profile information in correspondence to the size of the purchase.

6. The method of claim 1 wherein client biometric data is computationally analyzed to provide sentiment analysis for improvement to customer service, and wherein sentiment analysis may be computed for an individual customer, or computed across the customer population for determining a statistical account of customer satisfaction.

7. The method of claim 1 wherein the merchant or service provider may record client preferences information, and wherein the preferences information is displayed on the merchant or service provider user interface upon recognition of the client identity.

8. A method for completing reservations comprising:
confirming a reservation, wherein a client selects a reservation preference and informs the service provider;
arriving at the service provider, wherein the client visits the service provider for the rendering of services defined by the reservation;
sampling client biometric data at a sensor array, wherein the client biometric data comprises facial, voice, or thumbprint data;
recognizing the client identity; wherein recognizing the client identity comprises matching the biometric data with a client identity profile;
authenticating and authorizing the service provider access to the client identity profile, wherein the client identity profile comprises at least a name or account information; and
displaying the client identity profile information on a service provider user interface.

9. The method of claim 8 wherein a probabilistic model or a machine learning model is used for matching the biometric data with a client identity profile.

10. The method of claim 8 wherein the client identity profile may comprise a person's name, account name, account number, transaction history, email address, phone number, photograph, fingerprint, voice sample, biometric data, location, payment method, bank account, credit card, or debit card.

11. The method of claim 8 wherein a multi-layered approach is used for authenticating and authorizing the service provider access to the client identity profile, and wherein transactions or purchases are authorized with additional layers of client identity profile information in correspondence to the size of the purchase.

12. The method of claim 8 wherein client biometric data is computationally analyzed to provide sentiment analysis for automated improvement to customer service, and wherein sentiment analysis may be computed for an individual customer, or computed across the customer population for determining a statistical account of customer satisfaction.

13. The method of claim 8 wherein the service provider gives the client dynamically personalized service generated from sentiment analysis or transaction history data.

14. The method of claim 8 wherein the service provider may record client preferences information, and wherein the preferences information is displayed on the merchant or service provider user interface upon recognition of the client identity.

15. A method for recognizing guest identities comprising:
acquiring and transmitting an image to a server for facial recognition;
recognizing one or more faces in the image;
incorporating facial recognition with client profile data to match profiles to the faces in source image;
sending the profile data of a matched client to a user device.

16. The method of claim 15 wherein the second server instance uses a probabilistic model and or a machine learning model for matching images with profile data.

17. The method of claim 15 wherein client metadata may comprise a person's name, account name, account number, transaction history, email address, phone number, photograph, fingerprint, voice sample, biometric data, location, payment method, bank account, credit card, or debit card.

18. The method of claim 15 wherein recognizing clients facilitates transactions with a merchant or service provider.

19. The method of claim 15 wherein guest images are computationally analyzed to provide sentiment analysis for improvement to customer service, and wherein sentiment analysis may be computed for an individual guest, or computed across a guest population for determining a statistical account of guest satisfaction.

20. The method of claim 15 wherein the display device and received guest image and metadata is used by a service provider for creating dynamically personalized service.
